(19) United States
(12) Patent Application Publication
(10) Pub. No.: US 2010/0285836 A1
(43) Pub. Date: Nov. 11, 2010

(54) RADIO COMMUNICATION DEVICE

(75) Inventors: Kenshi Horihata, Kanagawa (JP); Nobuhiro Iwai, Kanagawa (JP); Yasuhiro Kitajima, Kanagawa (JP); Nobuaki Tanaka, Osaka (JP); Hironori Kikuchi, Miyagi (JP)

Correspondence Address: Seed Intellectual Property Law Group PLLC, 701 Fifth Avenue, Suite 5400, Seattle, WA, 98104, US

(73) Assignee: PANASONIC CORPORATION, Osaka (JP)

(21) Appl. No.: 12/812,451

(22) PCT Filed: Dec. 25, 2008
(86) PCT No.: PCT/JP2008/003976

§ 371 Date: Jul. 9, 2010

(30) Foreign Application Priority Data
Jan. 10, 2008 (JP) 2008-003186

(51) Int. Cl. H04W 88/02

(52) U.S. Cl. 455/552.1

(57) ABSTRACT

Provided is a radio communication device which can prevent degradation of an antenna by controlling the VSWR and the current phase of antennas arranged adjacent to one another. In this device, an antenna (201) has a predetermined resonance frequency. A breaking circuit (203) is connected to the antenna (201) in parallel to a rectification circuit (205) so as to shut off the resonance frequency of the antenna (201). A termination circuit (204) electrically terminates the output side of the breaking circuit (203). An antenna (207) is arranged in the vicinity of the antenna (201) and has a resonance frequency different from a resonance frequency of the antenna (201). A breaking circuit (209) is connected to the antenna (207) in parallel to a rectification circuit (211) and shuts off the resonance frequency of the antenna (207). A termination circuit (210) terminates the output side of the breaking circuit (209).

### TECHNICAL FIELD

The present invention relates to a wireless communication apparatus. More particularly, the present invention relates to a wireless communication apparatus that performs communication using a plurality of adjacent antennas having different resonance frequencies.

### BACKGROUND ART

Recently, wireless communication apparatuses such as mobile telephones are equipped with multiple functions, and, accompanying this, communication apparatuses that have a plurality of antennas having different resonance frequencies such as antennas for cellular communication for speech communication and antennas receiving one-segment broadcasting of terrestrial digital broadcasting are becoming known. Further, wireless communication apparatuses are made smaller and thinner in recent years, and therefore antennas are arranged close in wireless communication apparatuses.

Conventionally, wireless communication apparatuses that prevent deterioration in antenna performance by switching between and using antennas of the wireless communication apparatuses having a plurality of antennas are known (see, for example, Patent Document 1). FIG. 1 is a block diagram showing a configuration of a conventional wireless communication apparatus that uses a plurality of antennas by switching between the antennas by means of switches.

The wireless communication apparatus of FIG. 1 has controlling section 10, antenna 11, matching circuit 12, switch 13, termination circuit 14, antenna 15, matching circuit 16, switch 17, termination circuit 18 and radio section 19.

Controlling section 10 controls switching of switch 13 and switch 17.

Antenna 11 has a predetermined resonance frequency.

Matching circuit 12 adjusts the impedance of signals received at antenna 11.

Switch 13 switches between connection of matching circuit 12 and termination circuit 14 and connection of matching circuit 12 and radio section 19, according to control by controlling section 10.

When connected with matching circuit 12 through switch 13, termination circuit 14 electrically terminates the output side of matching circuit 12.

Antenna 15 has a different resonance frequency from a resonance frequency of antenna 11.

Matching circuit 16 adjusts the impedance of signals received at antenna 15.

Switch 17 switches between connection of matching circuit 16 and termination circuit 18 and connection of matching circuit 16 and radio section 19, according to control by controlling section 10.

When connected with matching circuit 16 through switch 17, termination circuit 18 electrically terminates the output side of matching circuit 16.

Radio section 19 performs, for example, demodulation of signals received as input from matching circuit 12 through switch 13, or signals received as input from matching circuit 16 through switch 17.

With such a wireless communication apparatus, radio section 19 cannot receive and process signals having the resonance frequency of antenna 11 and signals having the resonance frequency of antenna 15 at the same time.

Accordingly, with a conventional wireless communication apparatus, when antennas having different resonance frequencies receive signals at the same timing, a radio section provided for each antenna performs reception processing as shown in FIG. 2 without switching between antennas.

FIG. 2 is a block diagram showing a configuration of conventional wireless communication apparatus 50 that can receive signals at the same timing at antennas having different resonance frequencies.

Wireless communication apparatus 50 has antenna 61, matching circuit 62, radio section 63, antenna 64, matching circuit 65 and radio section 66.

Antenna 61 has a predetermined resonance frequency.

Matching circuit 62 adjusts the impedance of signals received at antenna 61.

Radio section 63 performs radio processing of signals received as input from matching circuit 62.

Antenna 64 has a different resonance frequency from a resonance frequency of antenna 61.

Matching circuit 65 adjusts the impedance of signals received at antenna 64.

Radio section 66 performs radio processing of signals received as input from matching circuit 65.

### Patent Document 1: Japanese Patent Application Laid-Open No. 2004-363863

### DISCLOSURE OF INVENTION

### Problems to be Solved by the Invention

However, in case where a plurality of antennas are arranged close in a conventional apparatus, when each antenna operates, its current flows to other antennas, and therefore there is a problem that each antenna cannot perform ideal radiation and its antenna characteristics deteriorate.

It is therefore an object of the present invention to provide a wireless communication apparatus that can prevent deterioration in antenna characteristics by controlling the phases of currents and the voltage standing wave ratios (“VSWRs”) of a plurality of antennas that are arranged close.

### Means for Solving the Problem

The wireless communication apparatus according to the present invention employs a configuration which includes: a first antenna; a second antenna that is arranged close to the first antenna; a first signal processing section that processes a signal received at the first antenna; a first blocking section that is connected to the first antenna in parallel to the first signal processing section, and that blocks a resonance frequency of the first antenna; a first termination section that electrically terminates an output side of the first blocking section; and a second signal processing section that processes a signal received at the second antenna having a different resonance frequency from the resonance frequency of the first antenna.

### ADVANTAGEOUS EFFECTS OF INVENTION

According to the present invention, it is possible to prevent deterioration in antenna characteristics by controlling the phases of currents and the voltage standing wave ratios (“VSWRs”) of a plurality of antennas that are arranged close.

### BRIEF DESCRIPTION OF DRAWINGS

FIG. 1 is a block diagram showing a configuration of a conventional wireless communication apparatus;

FIG. 2 is a block diagram showing a configuration of a conventional wireless communication apparatus;

FIG. 3 is a plan view showing an interior of a wireless communication apparatus in the open state, according to Embodiment 1 of the present invention;

FIG. 4 is a block diagram showing a configuration of a wireless communication apparatus according to Embodiment 1 of the present invention;

FIG. 5 shows a configuration of a blocking circuit according to Embodiment 1 of the present invention;

FIG. 6 shows a configuration of a blocking circuit according to Embodiment 1 of the present invention;

FIG. 7 shows a configuration of a blocking circuit according to Embodiment 1 of the present invention;

FIG. 8 shows a configuration of a blocking circuit according to Embodiment 1 of the present invention;

FIG. 9 shows a configuration of a termination circuit according to Embodiment 1 of the present invention;

FIG. 10 shows a configuration of a termination circuit according to Embodiment 1 of the present invention;

FIG. 11 shows an equivalent circuit in a processing sequence of an antenna according to Embodiment 1 of the present invention;

FIG. 12 shows the relationship between VSWR and frequency according to Embodiment 1 of the present invention;

FIG. 13 shows the relationship between VSWR and frequency according to Embodiment 1 of the present invention;

FIG. 14 shows the relationship between VSWR and frequency according to Embodiment 1 of the present invention;

FIG. 15 shows the relationship between VSWR and frequency according to Embodiment 1 of the present invention;

FIG. 16 shows the relationship between an amplitude of a radio wave received at an antenna and an amplitude of a radio wave received at an antenna after the phase is adjusted in a termination circuit, according to Embodiment 1 of the present invention;

FIG. 17 is a block diagram showing a configuration of a wireless communication apparatus;

FIG. 18 shows the relationship between VSWR and frequency;

FIG. 19 shows the relationship between VSWR and frequency;

FIG. 20 is a plan view showing an interior of a wireless communication apparatus in the open state, according to Embodiment 2 of the present invention;

FIG. 21 shows a configuration of an antenna according to Embodiment 2 of the present invention;

FIG. 22 is a block diagram showing a configuration of a wireless communication apparatus according to Embodiment 2 of the present invention;

FIG. 23 shows an equivalent circuit in a processing sequence of an antenna according to Embodiment 2 of the present invention;

FIG. 24 is a block diagram showing a configuration of a wireless communication apparatus according to Embodiment 3 of the present invention; and

FIG. 25 shows the relationship between VSWR and frequency according to Embodiment 3 of the present invention.

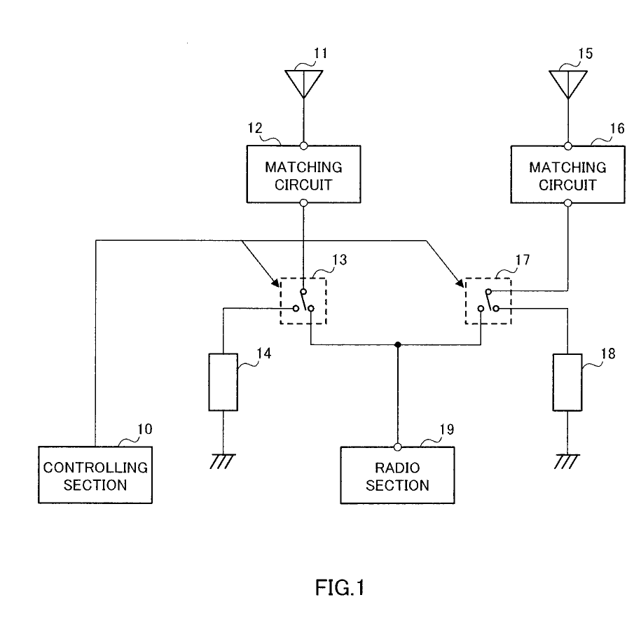

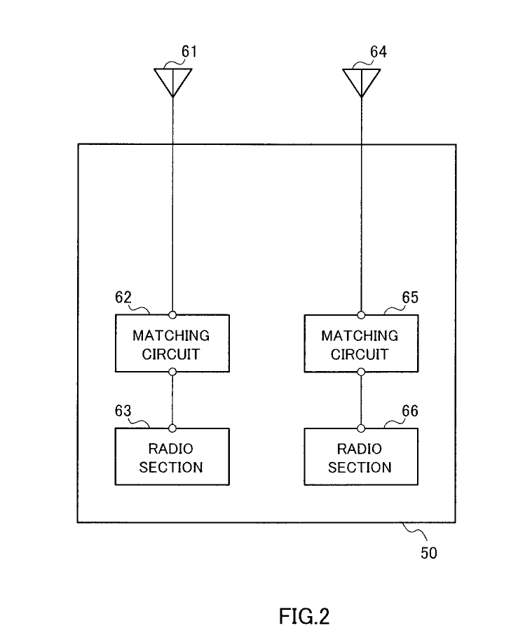

### BEST MODE FOR CARRYING OUT THE INVENTION

Hereinafter, embodiments of the present invention will be explained in detail with reference to the accompanying drawings.

### Embodiment 1

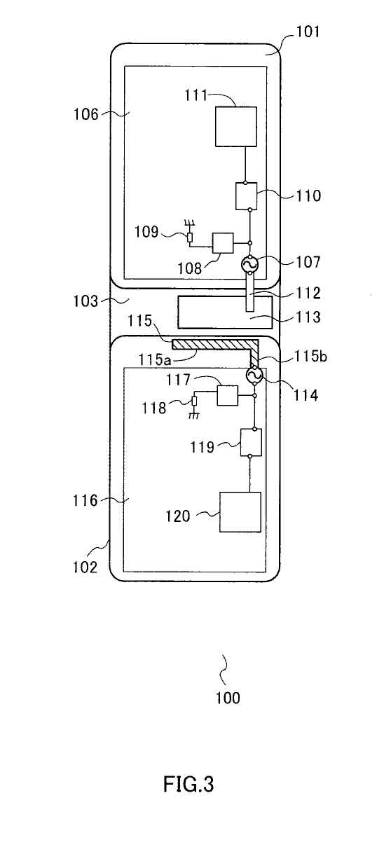

FIG. 3 is a plan view showing an interior of wireless communication apparatus 100 in the open state, according to Embodiment 1 of the present invention.

With wireless communication apparatus 100, first housing 101 and second housing 102 are coupled rotatably by hinge part 103. Further, wireless communication apparatus 100 is folded when first housing 101 and second housing 102 overlap mutually, and is opened from the folded state as shown in FIG. 3 when first housing 101 or second housing 102 is rotated about hinge part 103.

First housing 101 includes circuit board 106 inside.

Second housing 102 includes circuit board 116 inside.

Hinge part 103 includes hinge conductive part 113.

Circuit board 106 is provided with power feeding section 107, and is also provided with blocking circuit 108, termination circuit 109, matching circuit 110 and radio section 111. Further, circuit board 106 has a layer structure. Furthermore, the first layer forming the layer structure of circuit board 106 is the ground plane (not shown), and the ground plane is printed on virtually the entire surface of circuit board 106. Note that blocking circuit 108, termination circuit 109, matching circuit 110 and radio section 111 will be described later.

Power feeding section 107 feeds power to the ground plane of circuit board 106, in the vicinity of hinge part 103, and feeds power to hinge conductive part 113 through conductive part 112.

Conductive part 112 is made of a flexible material, and electrically connects power feeding section 107 and hinge conductive part 113.

Hinge conductive part 113 is made of an electrically conductive member, and functions as the axis of rotation when hinge part 103 rotates.

Power feeding section 114 feeds power to antenna 115.

Antenna 115 is, for example, an antenna for cellular communication, and is fed power from power feeding section 114. Further, antenna 115 is formed with long strip part 115a and short strip part 115b that is provided to extend from one end of long strip part 115a in a direction vertical to the longitudinal direction of long strip part 115a, making the whole body virtually an L shape. Furthermore, power feeding section 114 feeds power to antenna 115 from the front end part of short strip part 115b.

Circuit board 116 is provided with power feeding section 114, and is also provided with blocking circuit 117, termination circuit 118, matching circuit 119 and radio section 120. Further, circuit board 116 has a layer structure. Furthermore, the first layer forming the layer structure of circuit board 116 is the ground plane (not shown), and the ground plane is printed on virtually the entire surface of circuit board 116. Note that blocking circuit 117, termination circuit 118, matching circuit 119 and radio section 120 will be described later.

With wireless communication apparatus 100, a display section (not shown) is provided in first housing 101, and an operating part (not shown) such as a key switch that is operated upon speech communication is provided in second housing 102.

With wireless communication apparatus 100, power feeding section 107 feeds power to the ground plane of circuit board 106 and hinge conductive part 113. Further, in wireless communication apparatus 100, long strip part 115a of antenna 115 is arranged close to hinge conductive part 113, and therefore when long strip part 115a of antenna 115 and hinge conductive part 113 are electrically connected by capacitive coupling, hinge conductive part 113 and antenna 115 are electrically connected by capacitive coupling. By this means, with wireless communication apparatus 100, antennas are formed with the ground plane of circuit board 106, hinge conductive part 113, antenna 115 and the ground plane of circuit board 116. Therefore, wireless communication apparatus 100 has two antennas including antenna 115 and the antenna formed with the ground plane of circuit board 106, hinge conductive part 113, antenna 115 and the ground plane of circuit board 116. For example, the antenna formed with the ground plane of circuit board 106, hinge conductive part 113, antenna 115 and the ground plane of circuit board 116 is a dipole antenna that has an electrical length of half of the wavelength, and is used for one-segment broadcasting of terrestrial digital broadcasting.

Antenna 115 and the antenna formed with the ground plane of circuit board 106, hinge conductive part 113, antenna 115 and the ground plane of circuit board 116 are arranged close, and therefore antenna 115 and the antenna formed with the ground plane of circuit board 106, hinge conductive part 113, antenna 115 and the ground plane of circuit board 116 influence each other by their amplitudes.

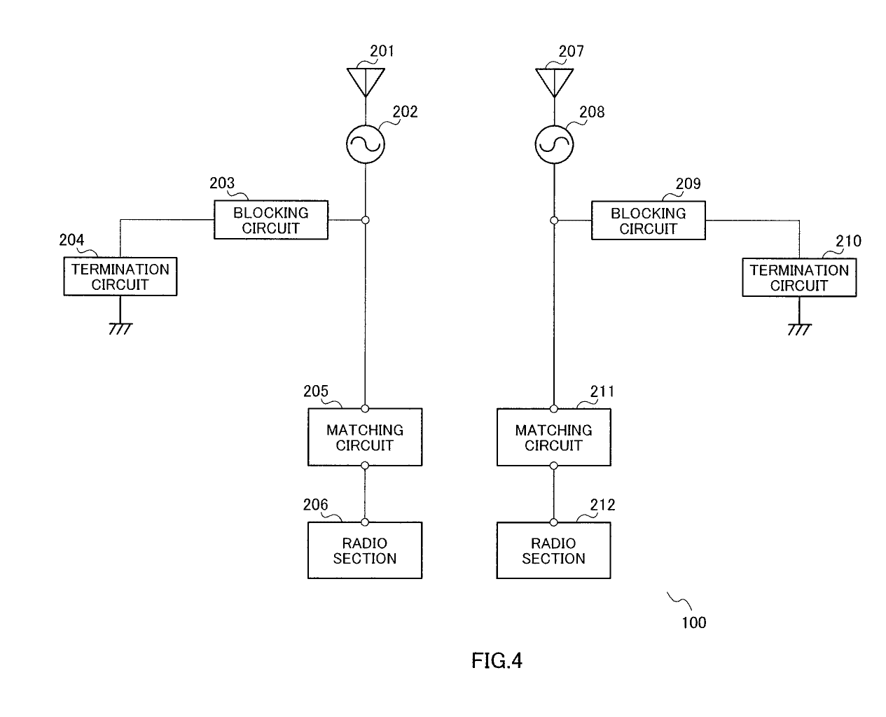

Next, a more detailed configuration of wireless communication apparatus 100 will be explained using FIG. 4. FIG. 4 is a block diagram showing a configuration of wireless communication apparatus 100.

In FIG. 4, matching circuit 205 and radio section 206 form a signal processing means for processing signals received at antenna 201. Further, matching circuit 211 and radio section 212 form a signal processing means for processing signals received at antenna 207.

Antenna 201 corresponds to antenna 115 of FIG. 3 and is, for example, an antenna for cellular communication, with a resonance frequency in the range of 2 GHz.

Power feeding section 202 corresponds to power feeding section 114 of FIG. 3, and feeds power to antenna 201 and is electrically connected to blocking circuit 203 and matching circuit 205. Further, power feeding section 202 indicates the border between the radio section and the antenna.

Blocking circuit 203 corresponds to blocking circuit 117 of FIG. 3, and is connected to antenna 201 in parallel to matching circuit 205 and blocks the resonance frequency of antenna 201. Blocking circuit 203 is, for example, an LC parallel resonance circuit, lowpass filter, highpass filter or bandpass filter. Further, blocking circuit 203 blocks, for example, the frequency in the range of 2 GHz which is the resonance frequency of antenna 201. Note that the detailed configuration of blocking circuit 203 will be described later.

Termination circuit 204 corresponds to termination circuit 118 of FIG. 3, and electrically terminates the output side of blocking circuit 203 and connects the output side of termination circuit 204 to the ground. Note that the detailed configuration of termination circuit 204 will be described later.

Matching circuit 205 is a circuit that corresponds to matching circuit 119 of FIG. 3 and that makes the impedance in antenna 201 and the input impedance in radio section 206 match, and adjusts the impedance of signals received at antenna 201 and outputs the signals to radio section 206.

Radio section 206 corresponds to radio section 120 of FIG. 3, and performs processing such as demodulation of the signals received as input from matching circuit 205.

Antenna 207 corresponds to the antenna formed with the ground plane of circuit board 106, hinge conductive part 113, antenna 115 and the ground plane of circuit board 116 of FIG. 3. Further, antenna 207 is arranged close to antenna 201 and is, for example, an antenna for one-segment broadcasting of terrestrial digital broadcasting, with a resonance frequency in the range of 500 MHz.

Power feeding section 208 corresponds to power feeding section 107 of FIG. 3, and feeds power to antenna 207 and is electrically connected to blocking circuit 209 and matching circuit 211.

Blocking circuit 209 corresponds to blocking circuit 108 of FIG. 3, and is connected to antenna 207 in parallel to matching circuit 211 and blocks the resonance frequency of antenna 207. Blocking circuit 209 is, for example, an LC parallel resonance circuit, lowpass filter, highpass filter or bandpass filter. Further, blocking circuit 209 blocks, for example, the frequency in the range of 500 MHz which is the resonance frequency of antenna 207. Note that the detailed configuration of blocking circuit 209 will be described later.

Termination circuit 210 corresponds to termination circuit 109 of FIG. 3, and electrically terminates the output side of blocking circuit 209 and connects the output side of termination circuit 210 to the ground. Note that the detailed configuration of termination circuit 210 will be described later.

Matching circuit 211 is a circuit that corresponds to matching circuit 110 of FIG. 3 and that makes the impedance in antenna 207 and the input impedance in radio section 212 match, and adjusts the impedance of signals received at antenna 207 and outputs the signals to radio section 212.

Radio section 212 corresponds to radio section 111 of FIG. 3, and performs processing such as demodulation of the signals received as input from matching circuit 211.

Next, the configuration of blocking circuit 203 will be explained using FIG. 5 to FIG. 7. FIG. 5 shows a configuration of blocking circuit 203 in case where an LC parallel resonance circuit is used.

As shown in FIG. 5, blocking circuit 203 is an LC parallel resonance circuit in which reactance 203a and capacitance 203b are connected in parallel, and employs a circuit configuration in which this LC parallel resonance circuit is connected in series between antenna 201 and termination circuit 204. Then, blocking circuit 203 blocks the resonance frequency of antenna 201 by this LC parallel resonance circuit, and allows other frequencies to pass. For example, blocking circuit 203 blocks the frequency in the range of 2 GHz, and allows frequencies outside the range of 2 GHz to pass.

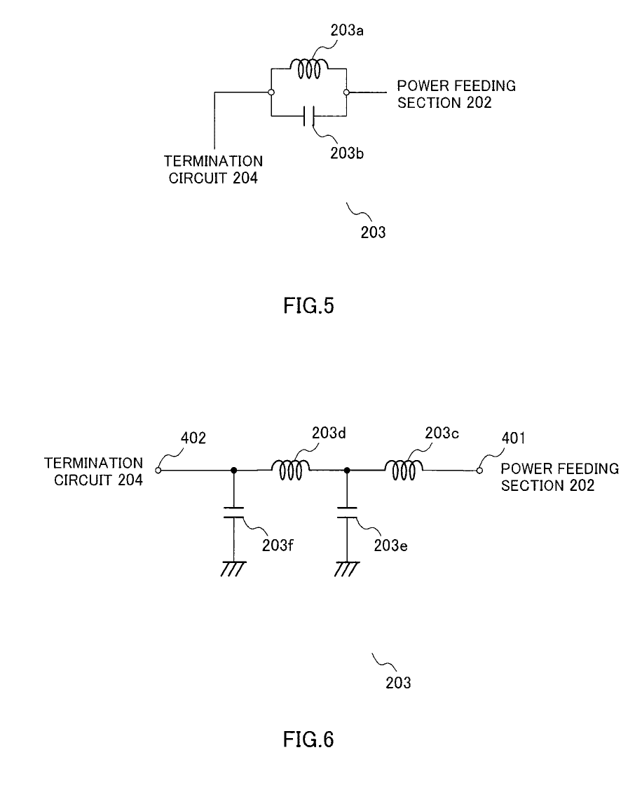

Further, FIG. 6 shows a configuration of blocking circuit 203 in case where a lowpass filter is used.

As shown in FIG. 6, blocking circuit 203 is a lowpass filter circuit in which reactance 203c and reactance 203d are connected in series between power feeding section 202 and termination circuit 204, in which one of the output sides of reactance 203c which are branched into two, is grounded through capacitor 203e and the other is connected with reactance 203d and in which one of the output sides of reactance 203d which are branched into two, is grounded through capacitor 203f and the other is connected to termination circuit 204. Then, blocking circuit 203 blocks the resonance frequency of antenna 201 by this lowpass filter circuit, and allows other frequencies to pass. For example, blocking circuit 203 uses 1.5 GHz as the cutoff frequency. Note that, by changing terminal 401 to be connected with power feeding section 202 and terminal 402 to be connected with termination circuit 204, it is equally possible to connect terminal 401 with termination circuit 204 and connect terminal 402 with power feeding section 202.

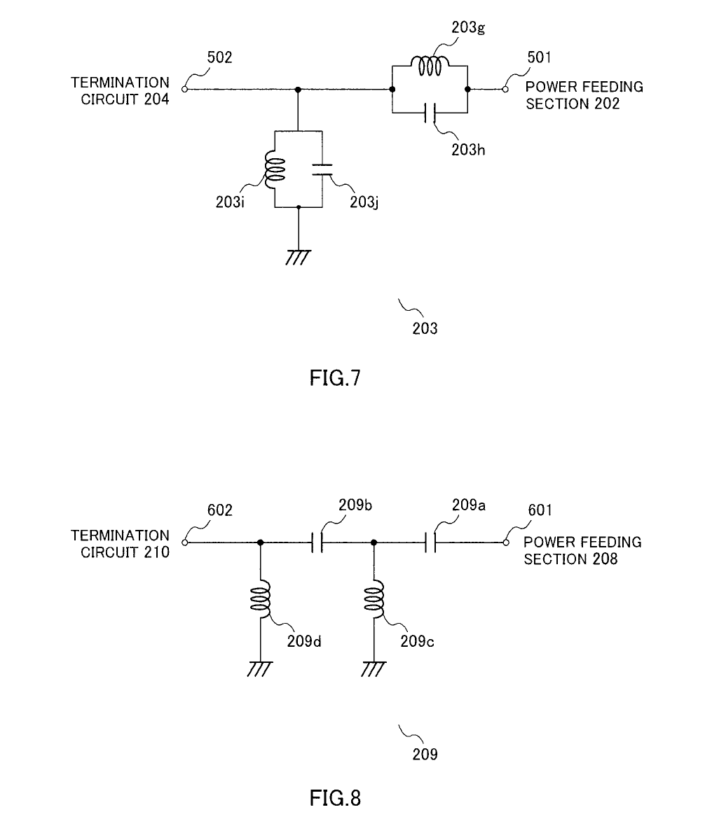

Further, FIG. 7 shows a configuration of blocking circuit 203 in case where a bandpass filter is used.

As shown in FIG. 7, blocking circuit 203 is a bandpass filter circuit in which the LC parallel resonance circuit in which reactance 203g and capacitor 203h are connected in parallel, is connected in series between power feeding section 202 and termination circuit 204, and in which one of the output sides of this LC parallel resonance circuit which are branched into two, is grounded through the LC parallel resonance circuit in which reactance 203i and capacitor 203j are connected in parallel, and the other is connected to termination circuit 204. Then, blocking circuit 203 blocks the resonance frequency of antenna 201 by this bandpass filter circuit, and allows other frequencies to pass. For example, blocking circuit 203 allows the frequency of 500 MHz, which is the resonance frequency of antenna 207, to pass, and blocks frequencies other than 500 MHz. Note that, by changing terminal 501 to be connected with power feeding section 202 and terminal 502 to be connected with termination circuit 204, it is equally possible to connect terminal 501 with termination circuit 204 and connect terminal 502 with power feeding section 202.

Next, the configuration of blocking circuit 209 will be explained using FIG. 8. FIG. 8 shows a configuration of blocking circuit 209 in case where a highpass filter circuit is used.

As shown in FIG. 8, blocking circuit 209 is a highpass filter circuit in which capacitor 209a and capacitor 209b are connected in series between power feeding section 208 and termination circuit 210, in which one of the output sides of capacitor 209a which are branched into two, is grounded through reactance 209c and the other is connected with capacitor 209b and in which one of the output sides of capacitor 209b which are branched into two, is grounded through reactance 209d and the other is connected to termination circuit 210. Then, blocking circuit 209 blocks the resonance frequency of antenna 201 by this highpass filter circuit, and allows other frequencies to pass. For example, blocking circuit 209 uses 1.5 GHz as the cutoff frequency. Note that, by changing terminal 601 to be connected with power feeding section 208 and terminal 602 to be connected with termination circuit 204, it is equally possible to connect terminal 601 with termination circuit 204 and connect terminal 602 with power feeding section 202.

Further, blocking circuit 209 may have the same configuration as the LC parallel resonance circuit of FIG. 5. In this case, blocking circuit 209 blocks the resonance frequency of antenna 207 by this LC parallel resonance circuit, and allows other frequencies to pass. For example, blocking circuit 209 blocks the frequency in the range of 500 MHz, and allows frequencies outside the range of 500 MHz to pass.

Further, blocking circuit 209 may have the same configuration as the bandpass filter circuit of FIG. 6. In this case, blocking circuit 209 blocks the resonance frequency of antenna 207 by this bandpass filter circuit, and allows other frequencies to pass. For example, blocking circuit 209 allows the frequency of 2 GHz, which is the resonance frequency of antenna 201, to pass, and blocks frequencies other than 2 GHz.

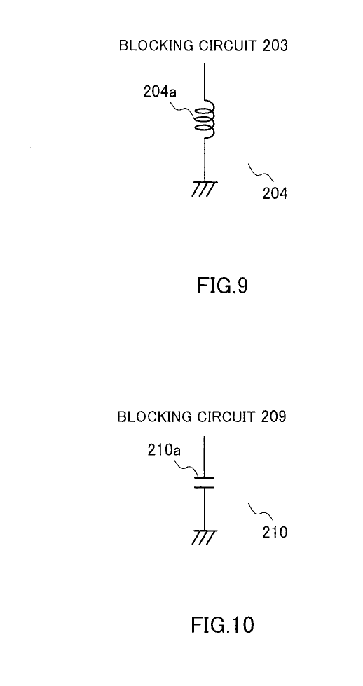

Next, the configuration of termination circuit 204 will be explained using FIG. 9. FIG. 9 shows the configuration of termination circuit 204.

Termination circuit 204 employs a circuit configuration in which reactance 204a is connected in series between blocking circuit 203 and the ground.

Next, the configuration of termination circuit 210 will be explained using FIG. 10. FIG. 10 shows the configuration of termination circuit 210.

Termination circuit 210 employs a circuit configuration in which capacitor 210a is connected in series between blocking circuit 209 and the ground.

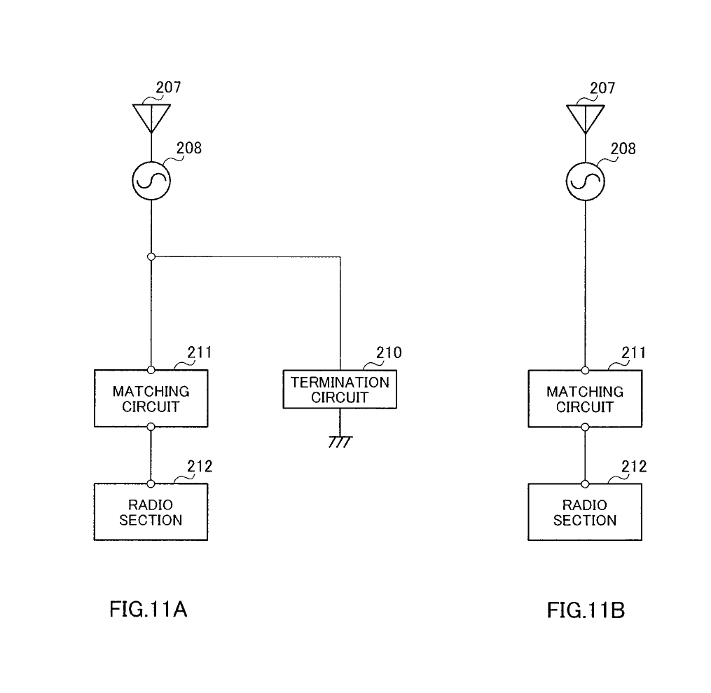

FIG. 11 is an equivalent circuit in a processing sequence of antenna 207. Note that the processing sequence of antenna 207 is a sequence formed with antenna 207, power feeding section 208, blocking circuit 209, termination circuit 210, matching circuit 211 and radio section 212.

FIG. 11A shows an equivalent circuit in case of the resonance frequency of antenna 201, and FIG. 11B shows an equivalent circuit in case of the resonance frequency of antenna 207.

As shown in FIG. 11A, in case of the resonance frequency of antenna 201, termination circuit 210 is connected in high-frequency coupling. By contrast with this, as shown in FIG. 11B, in case of the resonance frequency of antenna 207, termination circuit 210 is disconnected in high-frequency decoupling.

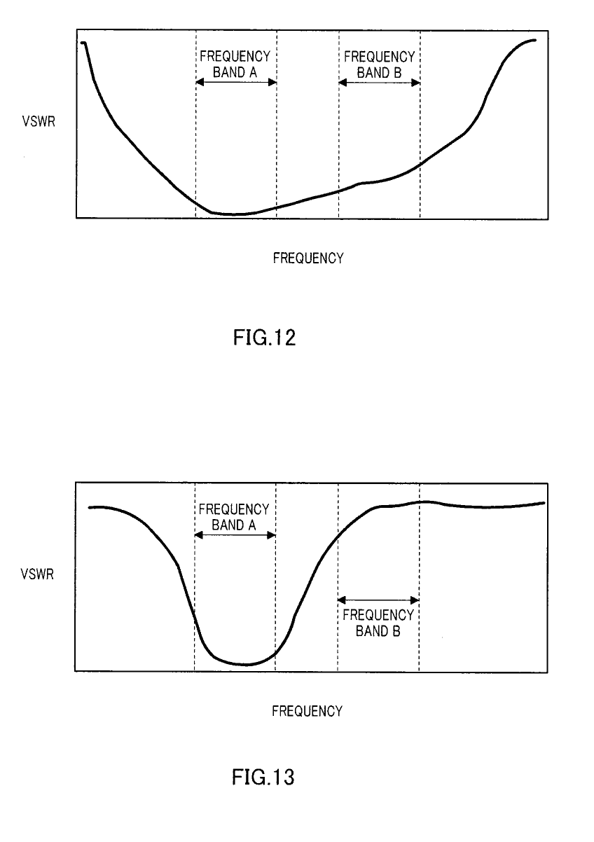

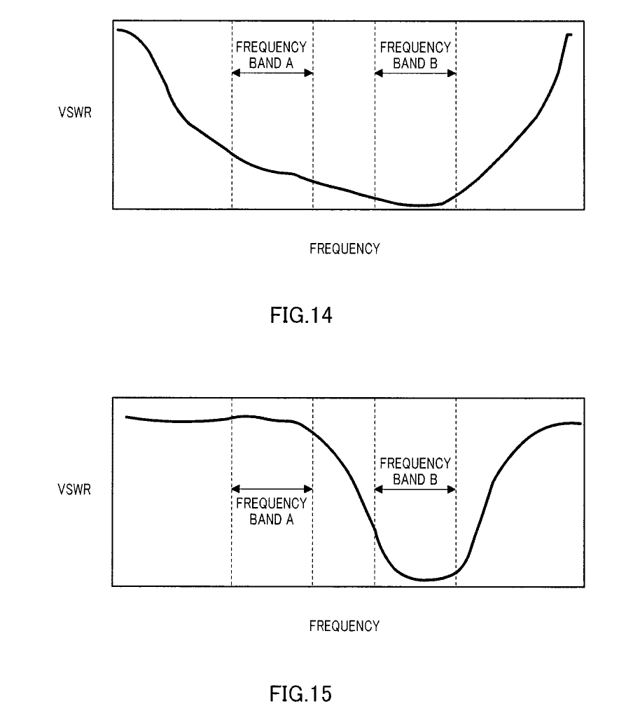

FIG. 12 to FIG. 15 show the relationship between voltage standing wave ratios (“VSWRs”) and frequencies. FIG. 12 shows the conventional relationship between VSWR and frequency, and FIG. 13 shows the relationship between VSWR and frequency at antenna 201 according to the present embodiment. Further, FIG. 14 shows the conventional relationship between VSWR and frequency, and FIG. 15 shows the relationship between VSWR and frequency at antenna 207 according to the present embodiment. Note that, for ease of explanation, it is assumed that the resonance frequency of antenna 201 is in frequency band A and the resonance frequency of antenna 207 is in frequency band B.

Here, the “VSWR” refers to the “voltage standing wave ratio.” In case where the impedance varies between an antenna and a coaxial cable, part of the high frequency energy is reflected and returns to the transmitting side. This wave returning to the transmitting side is referred to as “reflected wave.” A standing wave is produced when a traveling wave transmitted from a transmitter to an antenna and a reflected wave interfere with each other. Generally, in case where a VSWR is high, radio waves do not reach an antenna efficiently. Thus, the VSWR serves as an indicator for evaluating antenna performance.

According to the present embodiment, as shown in FIG. 12 and FIG. 13, with antenna 201, the VSWR in frequency band A does not change and the VSWR in frequency band B becomes high compared to a conventional VSWR, and, consequently, antenna 207 is not influenced by antenna 201 when antenna 207 operates. Further, according to the present embodiment, as shown in FIG. 14 and FIG. 15, with antenna 207, the VSWR in frequency band B does not change and the VSWR in frequency band A becomes high compared to a conventional VSWR, and, consequently, antenna 201 is not influenced by antenna 207 when antenna 201 operates.

Next, a method of preventing deterioration in antenna characteristics according to the present embodiment will be explained.

Generally, the current fed from power feeding section 202 attenuates more as the current flows in the ground plane of the circuit board farther away from power feeding section 202, and therefore the amount of current from feeding power section 202 is greater nearer power feeding section 202. Hence, antenna 207 is influenced more by power feeding section 202 nearer power feeding section 202. Under such circumstances, termination circuit 210 controls the phase of the current by changing the electrical length of antenna 207, and prevents deterioration in antenna characteristics by making the amplitude at antenna 207 different from the amplitude at antenna 201.

Here, in radio wave propagation, “electrical length” refers to the distance represented by the wavelength in the medium at a given frequency. Further, “phase” shows where, in a waveform of wavelength λ of a given frequency that adopts the electrical length as a period, a certain location is found in this period. Furthermore, the electrical length and phase can be represented by following equation 1 and equation 2.

Electrical Length Le[m]=Ve×L (Equation 1)

where “Ve” is a velocity coefficient (i.e. the ratio of electromagnetic wave transmission rates in vacuum and in medium) and “L” is the mechanical length (i.e. measured length).

Phase p[degree]=(L/λ)×1×π (Equation 2)

where “L” is the mechanical length (i.e. measured length) and “λ” is the wavelength. In view of above, phase p is determined uniquely from electrical length Le by substituting equation 2 into equation 1. Further, phase p at a given frequency having wavelength λ is determined based on mechanical length L and the velocity coefficient that is characteristics of a medium.

To be more specific, the relationship in equation 3 holds when it is assumed that the wavelength of a radio wave received at antenna 201 is λ, the distance between antenna 201 and antenna 207 in the ground plane is L, the electrical length in this case is Le, the amount of phase rotation at the resonance frequency of antenna 207 in termination circuit 210 is M and the electrical length in this case is Me.

Le+Me=(λ/4)×(2n+1) (where n is a natural number) (Equation 3)

Hence, termination circuit 210 controls phase M of antenna 207 using equation 3 so that the distance between the location at which the amplitude at antenna 201 maximizes and the location at which the amplitude of antenna 207 minimizes becomes shorter. Further, the amplitude at antenna 207 minimizes when electrical length Me from power feeding section 202 is λ/4, (3×λ)/4, (5×λ)/4, (7×λ)/4, . . . , and (λ×(2n+1))/4.

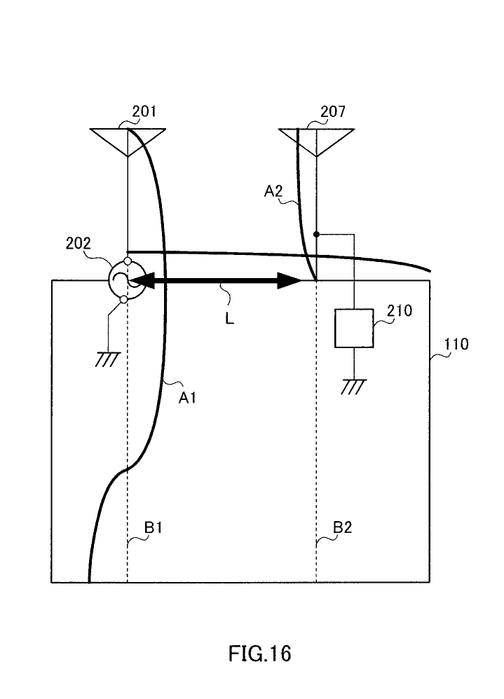

FIG. 16 shows the relationship between the amplitude of a signal received at antenna 201 and the amplitude of a signal received at antenna 207 after its phase is adjusted in termination circuit 210. The phase is controlled so that, as shown in FIG. 16, the distance between the location at which amplitude A1 (i.e. the magnitude in the horizontal direction with respect to broken line B1 of FIG. 16) of a signal received at antenna 201 maximizes and the location at which amplitude A2 (i.e. the magnitude in the horizontal direction with respect to broken line B2 of FIG. 16) of a signal received at antenna 207 minimizes becomes shorter. By making the maximum value of the amplitude and the minimum value of the amplitude match as described above, it is possible to remove the influence of antenna 207 when antenna 201 is used.

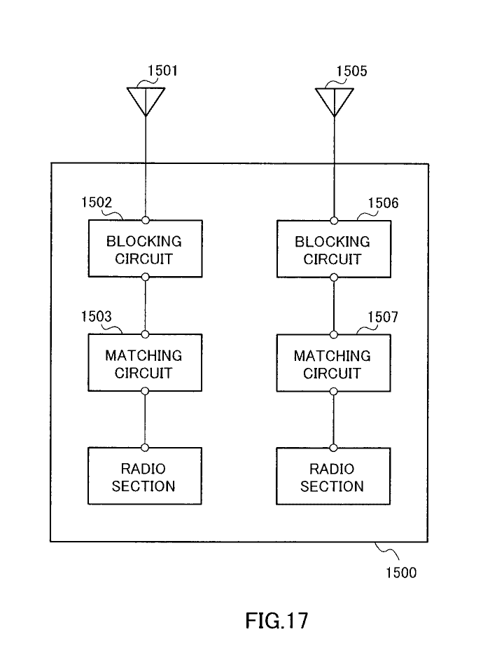

In case where a blocking circuit is connected in series between an antenna and a matching circuit, it is not possible to provide an advantage of the present embodiment. FIG. 17 is a block diagram showing a configuration of wireless communication apparatus 1500 in which blocking circuits 1502 and 1506 are connected in series between antennas 1501 and 1505 and matching circuits 1503 and 1507. In case of FIG. 17, passage loss occurs in desired bands of blocking circuit 1502 and blocking circuit 1506.

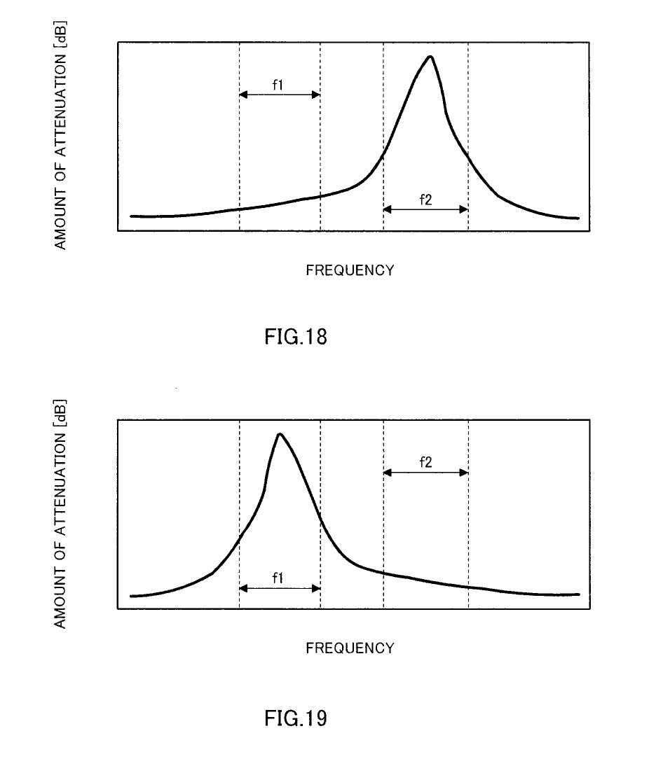

FIG. 18 shows attenuation characteristics of blocking circuit 1502, and FIG. 19 shows attenuation characteristics of blocking circuit 1506.

As shown in FIG. 18, although wireless communication apparatus 1500 makes the amount of attenuation of resonance frequency f2 of antenna 1505 greater by providing blocking circuit 1502, desired frequency f1 attenuates due to passage loss. Similarly, as shown in FIG. 19, although wireless communication apparatus 1500 can make the amount of attenuation of resonance frequency f1 of antenna 1501 greater by providing blocking circuit 1506, desired frequency f2 attenuates due to passage loss.

As described above, according to the present embodiment, it is possible to prevent deterioration in antenna characteristics by controlling phases of currents and VSWRs of a plurality of antennas that are arranged close.

### Embodiment 2

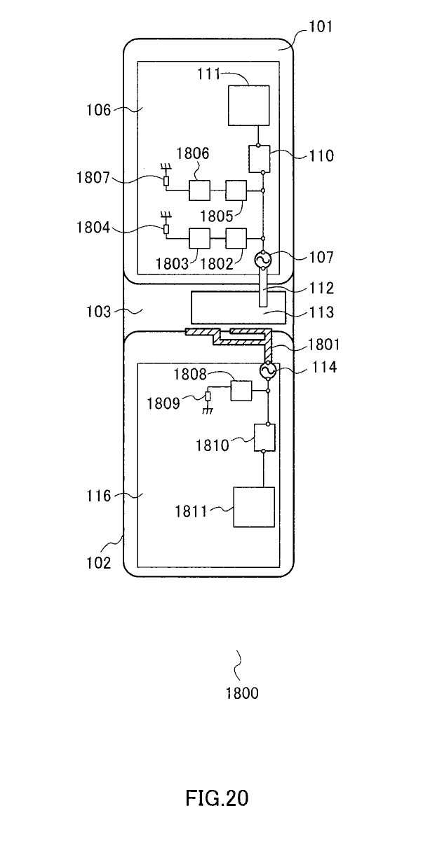

FIG. 20 is a plan view showing an interior of wireless communication apparatus 1800 in the open state, according to Embodiment 2 of the present invention.

Compared to wireless communication apparatus 100 according to Embodiment 1 shown in FIG. 3, wireless communication apparatus 1800 shown in FIG. 20 has antenna 1801 instead of antenna 115. Note that, in FIG. 20, the same components as in FIG. 3 will be assigned the same reference numerals and explanation thereof will be omitted.

Power feeding section 114 feeds power to antenna 1801.

Circuit board 116 is provided with power feeding section 114, and is also provided with blocking circuit 1808, termination circuit 1809, matching circuit 1810 and radio section 1811. Further, circuit board 116 has a layer structure. Furthermore, the first layer forming the layer structure of circuit board 116 is the ground plane (not shown), and the ground plane is printed on virtually the entire surface of circuit board 116. Note that blocking circuit 1808, termination circuit 1809, matching circuit 1810 and radio section 1811 will be described later.

Circuit board 106 is provided with power feeding section 107, and is also provided with blocking circuit 1802, blocking circuit 1803, termination circuit 1804, blocking circuit 1805, blocking circuit 1806, termination circuit 1807, matching circuit 110 and radio section 111. Further, circuit board 106 has a layer structure. Furthermore, the first layer forming the layer structure of circuit board 106 is the ground plane (not shown), and the ground plane is printed on virtually the entire surface of circuit board 106. Note that blocking circuit 1802, blocking circuit 1803, termination circuit 1804, blocking circuit 1805, blocking circuit 1806 and termination circuit 1807 will be described later.

Antenna 1801 is, for example, an antenna for cellular communication, and is fed power from power feeding section 114. Further, antenna 1801 has two different resonance frequencies. Note that the detailed configuration of antenna 1801 will be described later.

With wireless communication apparatus 1800, a display section (not shown) is provided in first housing 101, and an operating part (not shown) such as a key switch that is operated upon speech communication is provided in second housing 102.

With wireless communication apparatus 1800, power feeding section 107 feeds power to the ground plane of circuit board 106 and hinge conductive part 113, and high conductive part 113 and antenna 1801 are electrically connected by capacitive coupling. By this means, with wireless communication apparatus 1800, antennas are formed with the ground plane of circuit board 106, hinge conductive part 113, antenna 1801 and the ground plane of circuit board 116. Therefore, wireless communication apparatus 1800 has two antennas including antenna 1801 and the antenna formed with the ground plane of circuit board 106, hinge conductive part 113, antenna 1801 and the ground plane of circuit board 116. For example, the antenna formed with the ground plane of circuit board 106, hinge conductive part 113, antenna 1801 and the ground plane of circuit board 116 is a dipole antenna that has an electrical length of half of the wavelength, and is an antenna for one-segment broadcasting of terrestrial digital broadcasting.

Further, antenna 1801 functions as an antenna that is formed with the ground plane of circuit board 106, hinge conductive part 113, antenna 1801 and the ground plane of circuit board 116. Thus, antenna 1801 and the antenna formed with the ground plane of circuit board 106, hinge conductive part 113, antenna 1801 and the ground plane of circuit board 116 are arranged close, and therefore when one antenna operates, a current flows to the other antenna and thereby antenna performance deteriorates.

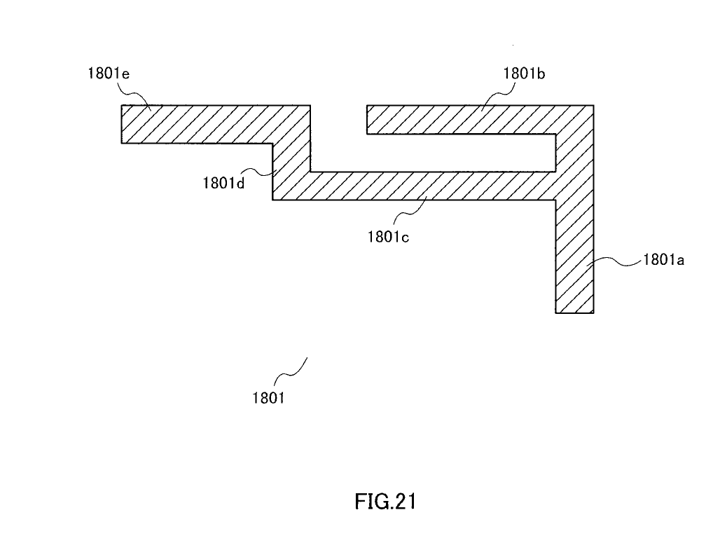

Next, a configuration of antenna 1801 will be explained using FIG. 21. FIG. 21 shows the configuration of antenna 1801.

With antenna 1801, the first antenna element is formed with first strip 1801a and second strip 1801b that is provided to extend from one end of first strip 1801a in a direction vertical to the longitudinal direction of first strip 1801a and that has virtually the same length in the longitudinal direction as the length of first strip 1801a in the longitudinal direction. Further, with antenna 1801, the second antenna element is formed with third strip 1801c that is provided to extend branching from virtually the center of first strip 1801a in the longitudinal direction, in a direction that is vertical to the longitudinal direction of first strip 1801a and that is the same as the direction in which second strip 1801b is provided to extend, connecting piece 1801d that is provided to extend from the front end part of third strip 1801c in a direction vertical to the longitudinal direction of third strip 1801c and front end strip 1801e that is provided to extend from the front end part of connecting piece 1801d, in a direction that is vertical to the longitudinal direction of connecting piece 1801d and that is the same as the direction in which third strip 1801c is provided to extend.

Furthermore, the first antenna element and the second antenna element of antenna 1801 have different electrical lengths and therefore have different resonance frequencies. For example, the first antenna element formed with first strip 1801a and second strip 1801b functions as an antenna that has an electrical length of virtually one-fourth in case of 2 GHz band. Further, the second antenna element formed with first strip 1801a, third strip 1801c, connecting piece 1801d and front end strip 1801e functions as an antenna that has an electrical length of virtually one-fourth in case of 800 MHz.

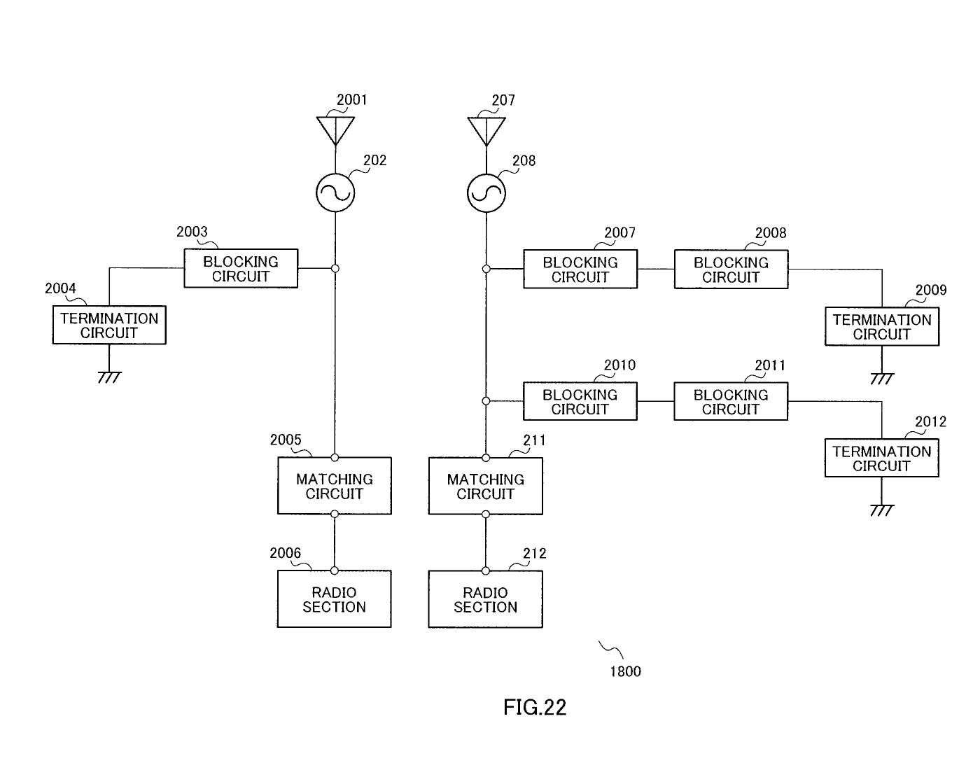

Next, a more detailed configuration of wireless communication apparatus 1800 will be explained using FIG. 22. FIG. 22 is a block diagram showing a configuration of wireless communication apparatus 1800. Note that, in FIG. 22, the same components as in FIG. 4 will be assigned the same reference numerals and explanation thereof will be omitted.

In FIG. 22, matching circuit 2005 and radio section 2006 form a signal processing means for processing signals received at antenna 2001.

Antenna 2001 corresponds to antenna 1801 of FIG. 20, and is arranged close to antenna 207, is, for example, an antenna for cellular communication, with two resonance frequencies. Antenna 2001 has, for example, resonance frequencies of 800 MHz and 2 GHz.

Power feeding section 202 feeds power to antenna 2001, and is electrically connected to blocking circuit 2003 and matching circuit 2005.

Blocking circuit 2003 corresponds to blocking circuit 1808 of FIG. 20, and is connected to antenna 2001 in parallel to matching circuit 2005 and blocks the resonance frequency of antenna 2001. Blocking circuit 2003 is, for example, an LC parallel resonance circuit, lowpass filter, highpass filter or bandpass filter. Further, blocking circuit 2003 blocks the frequencies of 800 MHz and 2 GHz which are the resonance frequencies of antenna 201. Note that the configuration of blocking circuit 2003 is the same as one of the configurations of FIG. 5 to FIG. 8, and therefore explanation thereof will be omitted.

Termination circuit 2004 corresponds to termination circuit 1809 of FIG. 20, and electrically terminates the output side of blocking circuit 2003 and connects the output side of termination circuit 2004 to the ground. Note that the configuration of termination circuit 2004 is the same as in FIG. 9 and therefore explanation thereof will be omitted.

Matching circuit 2005 is a circuit that corresponds to matching circuit 1810 of FIG. 20 and that makes the impedance in antenna 2001 and the input impedance in radio section 2006 match, and adjusts the impedance of signals received at antenna 2001 and outputs the signals to radio section 2006.

Radio section 2006 corresponds to radio section 1811 of FIG. 20, and performs predetermined radio processing with respect to signals received as input from matching circuit 2005 and then outputs them as received signals to be demodulated in the demodulating section (not shown).

Power feeding section 208 feeds power to antenna 207, and is electrically connected to blocking circuit 2007, blocking circuit 2010 and matching circuit 211.

Blocking circuit 2007 corresponds to blocking circuit 1802 of FIG. 20, and is connected to antenna 207 in parallel to matching circuit 211 and blocking circuit 2010 and blocks one resonance frequency of antenna 2001. Blocking circuit 2007 is, for example, an LC parallel resonance circuit, lowpass filter, highpass filter or bandpass filter. Further, blocking circuit 2007 blocks the frequency of 800 MHz which is the resonance frequency of antenna 2001. Note that the configuration of blocking circuit 2007 is the same as one of the configurations of FIG. 5 to FIG. 8, and therefore explanation thereof will be omitted.

Blocking circuit 2008 corresponds to blocking circuit 1803 of FIG. 20, and is connected in series between blocking circuit 2007 and termination circuit 2009 and blocks the resonance frequency of antenna 207. Blocking circuit 2008 is, for example, an LC parallel resonance circuit, lowpass filter, highpass filter or bandpass filter. Further, blocking circuit 2008 blocks frequencies between 470 MHz and 770 MHz which are resonance frequencies of antenna 207. Note that the configuration of blocking circuit 2007 is the same as one of the configurations of FIG. 5 to FIG. 8, and therefore explanation thereof will be omitted.

Termination circuit 2009 corresponds to termination circuit 1804 of FIG. 20, and electrically terminates the output side of blocking circuit 2008 and connects the output side of termination circuit 2009 to the ground. Termination circuit 2009 receives, for example, 10 nH as input. Note that the configuration of termination circuit 2009 is the same as in FIG. 9 or FIG. 10, and therefore explanation thereof will be omitted.

Blocking circuit 2010 corresponds to blocking circuit 1805 of FIG. 20, and is connected to antenna 207 in parallel to blocking circuit 2007 and matching circuit 211 and blocks one resonance frequency of antenna 2001 that is not blocked in blocking circuit 2007. Blocking circuit 2010 is, for example, an LC parallel resonance circuit, lowpass filter, highpass filter or bandpass filter. Further, blocking circuit 2010 blocks, for example, the frequency of 2 GHz, which is the resonance frequency of antenna 2001. Note that the configuration of blocking circuit 2010 is the same as one of the configurations of FIG. 5 to FIG. 8, and therefore explanation thereof will be omitted.

Blocking circuit 2011 corresponds to blocking circuit 1806 of FIG. 20, and is connected in series between blocking circuit 2010 and termination circuit 2012 and blocks the resonance frequency of antenna 207. Blocking circuit 2011 is, for example, an LC parallel resonance circuit, lowpass filter, highpass filter or bandpass filter. Further, blocking circuit 2011 blocks frequencies between 470 MHz and 770 MHz which are resonance frequencies of antenna 207. Note that the configuration of blocking circuit 2011 is the same as one of the configurations of FIG. 5 to FIG. 8, and therefore explanation thereof will be omitted.

Termination circuit 2012 corresponds to termination circuit 1807 of FIG. 20, and electrically terminates the output side of blocking circuit 2011 and connects the output side of termination circuit 2012 to the ground. Termination circuit 2012 receives, for example, 0.5 pF as input. Note that the configuration of termination circuit 2012 is the same as in FIG. 9 or FIG. 10, and therefore explanation thereof will be omitted.

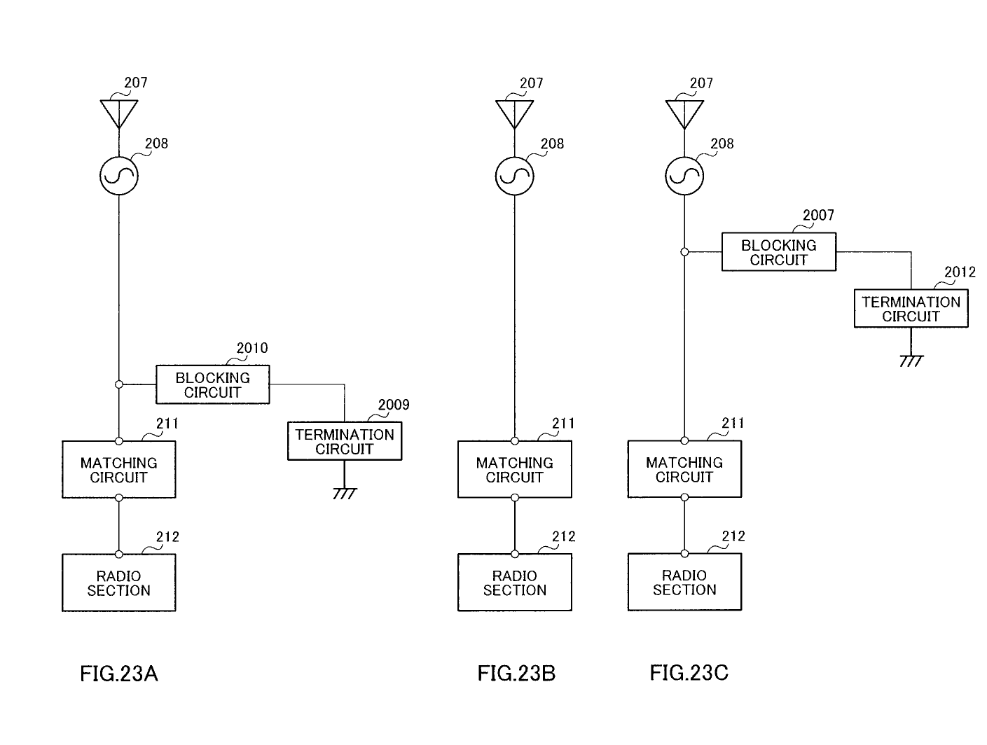

FIG. 23 is an equivalent circuit in a processing sequence of antenna 207. Note that the processing sequence of antenna 207 is a processing sequence formed with antenna 207, power feeding section 208, matching circuit 211, radio section 212, blocking circuit 2007, blocking circuit 2008, termination circuit 2009, blocking circuit 2010, blocking circuit 2011 and termination circuit 2012.

In case where antenna 2001 has resonance frequency A that is blocked in blocking circuit 2007 and resonance frequency C that is blocked in blocking circuit 2010 and antenna 207 has resonance frequency B, FIG. 23A shows an equivalent circuit in case of resonance frequency A of antenna 207, FIG. 23B shows an equivalent circuit in case of resonance frequency B of antenna 207 and FIG. 23C shows an equivalent circuit in case of resonance frequency C of antenna 207.

As shown in FIG. 23A, in case of resonance frequency A of antenna 2001, the presence of termination circuit 2009 is electrically recognized. Further, as shown in FIG. 23C, in case of resonance frequency C of antenna 2001, termination circuit 2012 is connected in high-frequency coupling. By contrast with this, as shown in FIG. 23B, in case of the resonance frequency of antenna 207, both termination circuit 2009 and termination circuit 2012 are disconnected in high-frequency decoupling.

As described above, according to the present embodiment, in case where an antenna having two resonance frequencies and an antenna having one resonance frequency are arranged close, it is possible to prevent deterioration in antenna characteristics by controlling VSWRs and phases of currents of a plurality of antennas that are arranged close.

### Embodiment 3

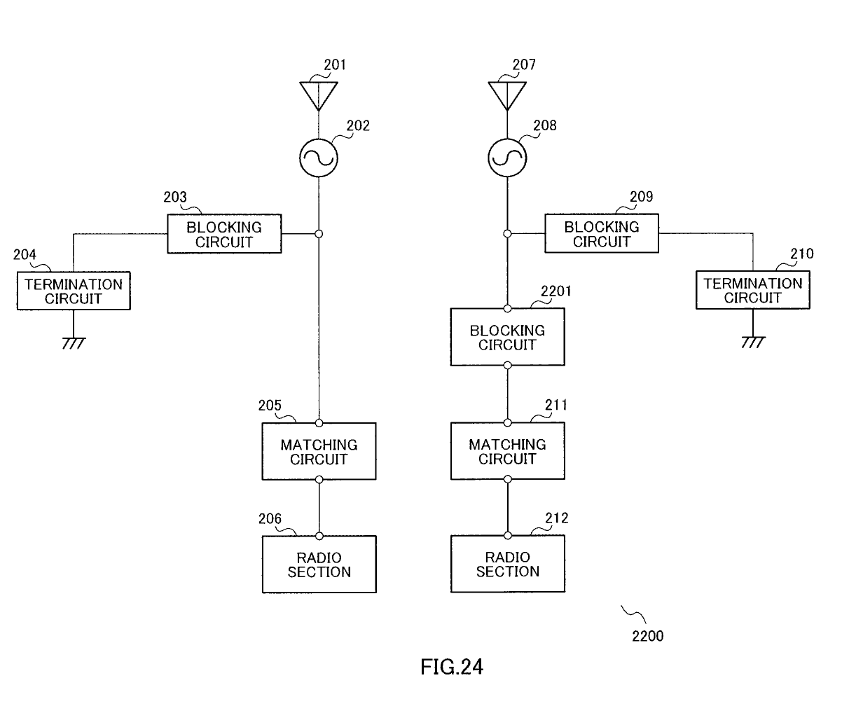

FIG. 24 is a block diagram showing a configuration of wireless communication apparatus 2200 according to Embodiment 3 of the present invention.

Wireless communication apparatus 2200 shown in FIG. 24 adds blocking circuit 2201 to wireless communication apparatus 100 according to Embodiment 1 shown in FIG. 4. Note that, in FIG. 24, the same components as in FIG. 4 will be assigned the same reference numerals and explanation thereof will be omitted. Further, the overall configuration of wireless communication apparatus 2200 is the same as in FIG. 3 except that a blocking circuit corresponding to blocking circuit 2201 is inserted between power feeding section 107 and matching circuit 110, and therefore explanation thereof will be omitted.

In FIG. 24, matching circuit 211 and radio section 212 form a signal processing means for processing signals received at antenna 207.

Power feeding section 208 feeds power to antenna 207, and is electrically connected to blocking circuit 209 and blocking circuit 2201.

Blocking circuit 2201 is connected in series between power feeding section 208 and matching circuit 211, and blocks the resonance frequency of antenna 201. Further, blocking circuit 2201 increases the VSWR at the resonance frequency of antenna 201 by increasing the amount of attenuation at the resonance frequency of antenna 201. Blocking circuit 2201 is, for example, an LC parallel resonance circuit.

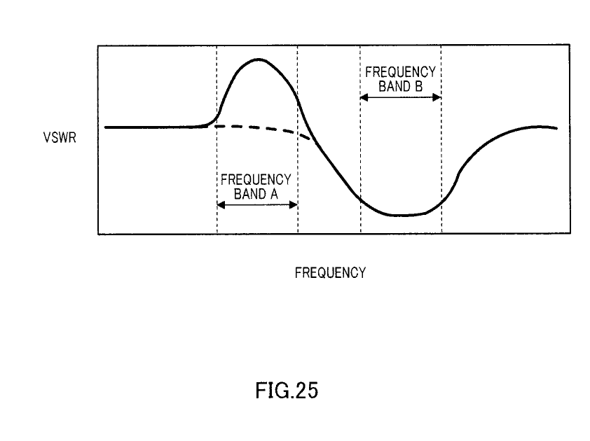

FIG. 25 shows the relationship between VSWR and frequency at the resonance frequency of antenna 207 according to the present embodiment. Note that, for ease of explanation, it is assumed that the resonance frequency of antenna 201 is in frequency band A and the resonance frequency of antenna 207 is in frequency band B.

As shown in FIG. 25, while the VSWR and frequency at resonance frequency A of antenna 201 are as shown by the broken line with Embodiment 1, the VSWR becomes greater as shown by the solid line with the present embodiment. Further, although passage loss in frequency band B which is the desired frequency increases at antenna 207 if blocking circuit 2201 is added, it is possible to increase the VSWR of frequency band A. Hence, the present embodiment provides an effective method in case where antenna characteristics of antenna 201 need to be improved even by risking antenna characteristics of antenna 207 a little. For example, in case where antenna 201 is an antenna for cellular communication and antenna 207 is an antenna for one-segment broadcasting of terrestrial digital broadcasting, the present embodiment is applicable to wireless communication apparatus 2200 that prioritizes speech communication performance over one-segment broadcasting reception performance.

As described above, in addition to the above advantage of Embodiment 1, the present embodiment can further improve the performance of adjacent antennas, by connecting blocking circuits that block resonance frequencies of adjacent antennas, in series between the antennas and matching circuits.

Further, with above Embodiments 1 to 3, although, for both of two adjacent antennas, the blocking circuits and the termination circuits are connected to the antennas in parallel to the matching circuits, the present invention is not limited to this and, for one of two adjacent antennas, it is possible to connect blocking circuits and termination circuits to the one antenna in parallel to matching circuits.

The disclosure of Japanese Patent Application No. 2008-003186, filed on Jan. 10, 2008, including the specification, drawings and abstract, is incorporated herein by reference in its entirety.

### INDUSTRIAL APPLICABILITY

The wireless communication apparatus according to the present invention is preferably adapted to perform communication using a plurality of adjacent antennas having different resonance frequencies.

1. A wireless communication apparatus comprising:
a first antenna;
a second antenna that is arranged close to the first antenna;
a first signal processing section that processes a signal received at the first antenna;
a second signal processing section that processes a signal received at the second antenna;
a first blocking section that is connected to the first antenna in parallel to the first signal processing section, that blocks a resonance frequency of the first antenna and that allows a resonance frequency of the second antenna to pass, the resonance frequency of the second antenna being different from the resonance frequency of the first antenna; and
a first termination section that electrically terminates an output side of the first blocking section.

2. The wireless communication apparatus according to claim 1, further comprising:
a second blocking section that is connected to the second antenna in parallel to the second signal processing section, and that blocks the resonance frequency of the second antenna and that allows the resonance frequency of the first antenna to pass; and
a second termination section that electrically terminates an output side of the second blocking section.

3. The wireless communication apparatus according to claim 1, further comprising a third blocking section that is connected in series between the first antenna and the first signal processing section, that is connected closer to the first signal processing section than the first blocking section and that blocks the resonance frequency of the second antenna.

4. The wireless communication apparatus according to claim 1, further comprising:
a second blocking section that is connected to the second antenna in parallel to the second signal processing section, that blocks a first resonance frequency of the first antenna and that allows a second resonance frequency of the first antenna to pass, the second resonance frequency of the first antenna being different from the first resonance frequency of the first antenna;
a third blocking section that blocks a first resonance frequency of the second antenna to be connected with an output side of the second blocking section, and that allows a second resonance frequency of the first antenna to pass, the second resonance frequency of the first antenna being different from the first resonance frequency of the second antenna;
a second termination section that terminates an output side of the third blocking section;
a fourth blocking section that is connected to the second signal processing section and the second blocking section in parallel, that blocks the second resonance frequency of the first antenna and that allows the first resonance frequency of the first antenna to pass;
a fifth blocking section that blocks the first resonance frequency of the second antenna to be connected to an output side of the fourth blocking section, and that allows the first resonance frequency of the first antenna to pass; and
a third termination section that terminates an output side of the fifth blocking section.

5. The wireless communication apparatus according to claim 1, wherein one of the first antenna and the second antenna is an antenna for cellular communication.
